(19) United States
(12) Patent Application Publication
(10) Pub. No.: US 2008/0231050 A1
(43) Pub. Date: Sep. 25, 2008

(54) METAL STRUCTURE DEFINING CIRCULAR FLANGED HOLE AND METHOD FOR MAKING THE SAME

(75) Inventors: WEN-TAO WANG, Shenzhen (CN); CHENG-HUNG LIN, Tu-Cheng (TW); ZHI-GANG HU, Shenzhen (CN); YONG ZENG, Shenzhen (CN); ZHI-GUO YANG, Shenzhen (CN); MING-GANG WANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HONGFU JIN PRECISION INDUSTRY (ShenZhen) CO., LTD., Shenzhen City (CN)

(21) Appl. No.: 11/944,463

(22) Filed: Nov. 23, 2007

(30) Foreign Application Priority Data
Mar. 21, 2007 (CN) 200710200313.1

(51) Int. Cl. F16L 23/00; B21D 31/02

(52) U.S. Cl. 285/405; 29/6.2

(57) ABSTRACT

An exemplary metal structure (10, 30) includes a base portion (14, 34), a flange (122, 322), and an edge portion (1241, 3241). The base portion defines a circular flanged hole (12, 32). The flange extends from a top surface of the base portion and the flange surrounds the circular flanged hole. The edge portion is configured for connecting an inside surface of the flange and the top surface of the base portion. The edge portion includes an edge surface, and a ratio of a radius of the edge surface (1242, 3242) of the edge portion with respect to a thickness of the base portion is less than 0.4. A method for making a circular flanged hole in a metal sheet (15) is also provided.

### BACKGROUND OF THE INVENTION

1. Field of the Invention

The present invention generally relates to metal structures and methods for making the same, and more particularly, to a metal structure defining a circular flanged hole and a method for making the same.

2. Discussion of the Related Art

Circular holes surrounded by flanges are called circular flanged holes. In the customary way of producing flanges surrounding circular holes in metal structures such as deformable metal sheets, it is customary first to pierce or define a preformed hole in the metal structure and then displace portions of the metal structures surrounding the circular hole from a surface of the metal structure to form the flange.

A typical method for making a circular flanged hole in a metal structure such as a sheet or a header plate will now be described. Firstly, a portion of a metal structure is cut out from the metal structure forming a preformed hole in the metal structure. Secondly, a circumferential portion of the preformed hole of the metal structure is deformed and displaced from a surface of the metal structure by a cylinder punch to form a flange. After the two steps, a flanged hole is formed in the metal structure. However, when using the typical method, a collapse portion is generally formed on an edge portion of the flanged hole because of high circumferential tensile deformation caused by the cylinder punch. In addition, if any impurity particles are accidentally adhered to the cylinder surface of the cylinder punch or if the cylinder punch is scratched, the circular flanged hole will be scratched, thus, decreasing the quality of the flanged hole. Furthermore, because the shape of the flanged hole is determined by the cross-section of the cylinder punch, the cross-section of the cylinder punch should be circular, or the shape of the flanged hole would not be circular.

Therefore, a metal structure defining a circular flanged hole is desired in order to overcome the above-described shortcomings. A new method for making a circular flanged hole in a metal sheet is also desired.

### SUMMARY

In one aspect, a metal structure includes a base portion, a flange, and an edge portion. The base portion defines a circular flanged hole. The flange extends from a top surface of the base portion and the flange surrounds the circular flanged hole. The edge portion is configured for connecting an inside surface of the flange and the top surface of the base portion. The edge portion includes an edge surface, and a ratio of a radius of the edge surface of the edge portion with respect to a thickness of the base portion is less than 0.4.

In another aspect, a method for making a circular flanged hole in a metal sheet, includes: punching through a metal sheet to form a preformed hole by a first punch; punching a circumferential portion of the preformed hole by a second punch to form a protruded portion, and a size of the second punch is larger than that of the first punch; and forming a flange surrounding the preformed hole by a drill bit.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present metal structure (and method). Moreover, in the drawings, like reference numerals designate corresponding parts throughout the several views, and all the views are schematic.

FIG. 1 is a cross-sectional view of a metal structure defining a circular flanged hole in accordance with a first preferred embodiment of the present invention.

FIG. 2 is an enlarged view of an encircled portion 11 shown in FIG. 1.

FIG. 3 is a cross-sectional view of a metal structure defining a circular flanged hole in accordance with a second preferred embodiment of the present invention.

FIG. 4 is an enlarged view of an encircled portion IV shown in FIG. 3.

FIG. 5 illustrates a first step in the practice of the method in accordance with the preferred embodiment of the present invention.

FIG. 6 illustrates a second step in the practice of the method in accordance with the preferred embodiment of the present invention.

FIG. 7 illustrates a third step in the practice of the method in accordance with the preferred embodiment of the present invention.

FIG. 8 is an isometric view of a punch used in third step of the method in accordance with the preferred embodiment of the present invention.

FIG. 9 is a cross-sectional view of the punch shown in FIG. 8, taken along line IX-IX thereof.

### DETAILED DESCRIPTION OF THE EMBODIMENTS

Reference will now be made to the drawings to describe preferred embodiments of the present metal structure defining a circular flanged hole in detail.

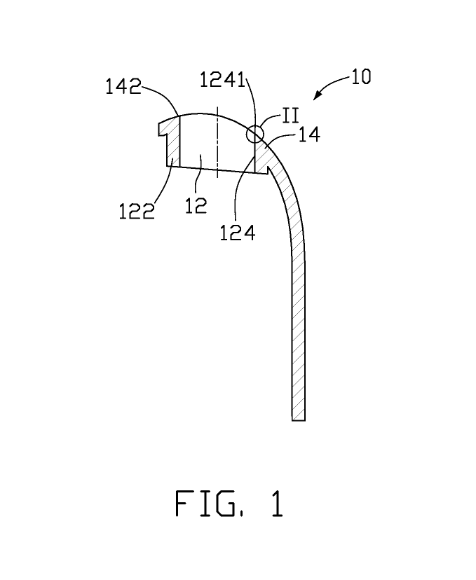

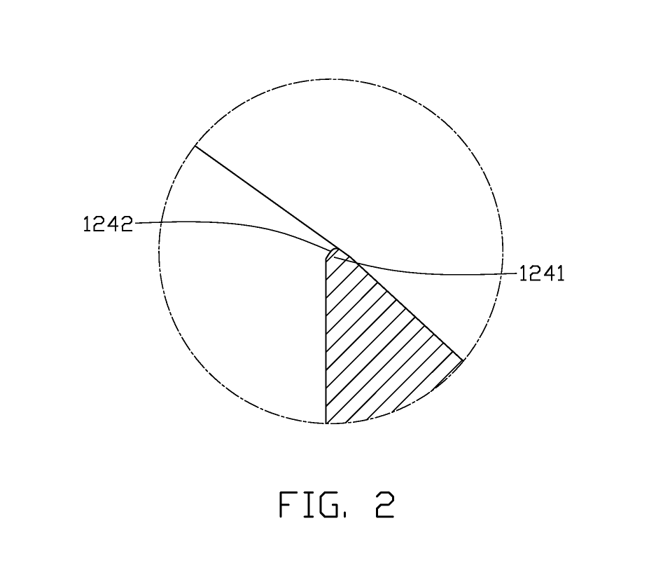

Referring to FIGS. 1 and 2, a metal structure 10 defining a circular flanged hole 12 in accordance with a first preferred embodiment is shown. The metal structure 10 includes a base portion 14 having a rounded top surface 142. In this embodiment, the rounded surface 142 is convex, however, the rounded top surface 142 can also be concave. The circular flanged hole 12 is surrounded by a flange 122 that extends from the rounded top surface 142. The flange 122 includes an inside surface 124 in the circular flanged hole 12. The metal structure 10 includes an edge portion 1241 connecting the inside surface 124 and the rounded top surface 142. The edge portion 1241 includes an edge surface 1242. The edge surface 1242 is substantially a rounded surface. A ratio of a radius of the edge surface 1242 of the edge portion 1241 with respect to a thickness of the base portion 14 is less than 0.4. For example, if the thickness of the base portion 14 is 10 mm, the radius of the edge surface 1242 will be less than 4 mm. The ratio of the radius of the edge surface 1242 of the edge portion 1241 with respect to the thickness of the base portion 14 is preferred to be less than 0.2, thus the edge portion 1241 is substantially sharp-cornered edge.

The metal structure 10 is made of metallic materials such as steel, aluminum, aluminum alloy, magnesium alloy, copper, and the like.

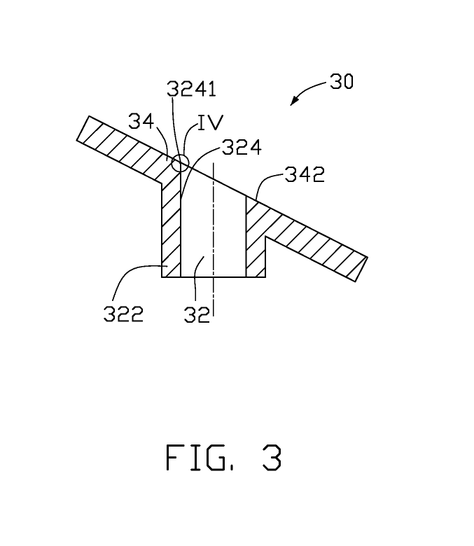

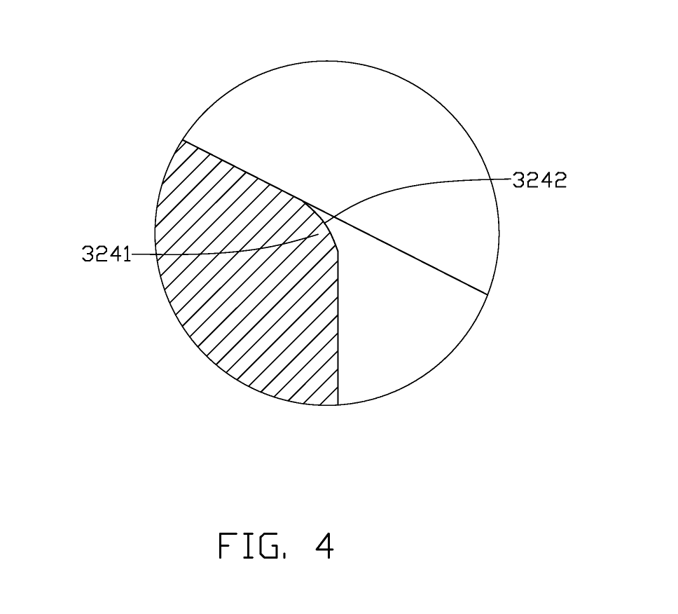

Referring to FIGS. 3 and 4, a metal structure 30 defining a circular flanged hole 32 in accordance with a second preferred embodiment is shown. The metal structure 30 includes a base portion 34 having a flat top surface 342 that is substantially flat. The circular flanged hole 32 is surrounded by a flange 322 that extends from the flat top surface 342. The flange 322 includes an inside surface 324 in the circular flanged hole 32. The inside surface 324 is oblique to the flat top surface 342. The metal structure 30 includes an edge portion 3241 connecting the inside surface 324 and the flat top surface 342. The edge portion 3241 includes an edge surface 3242. The edge surface 3242 is substantially a rounded surface. A ratio of a radius of the edge surface of the edge portion 3241 with respect to a thickness of the base portion 34 is less than 0.4. The ratio of the radius of the edge surface 3242 of the edge portion 3241 with respect to the thickness of the base portion 34 is preferred to be less than 0.2, thus the edge portion 3241 is substantially a sharp-cornered edge.

An exemplary method for making any of the above-described metal structures 10, and 30 will now be described as follows. The metal structure 10 of the first embodiment is taken here as an exemplary application, for the purposes of conveniently describing details of the exemplary method.

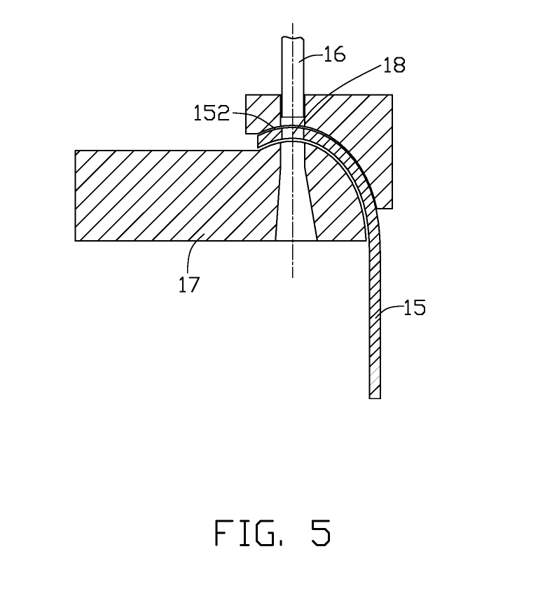

Referring to FIG. 5, in a first step, a metal sheet 15 including a rounded top surface 152 is provided. The metal sheet 15 is fixed by a clamping device 17. A first punch 16 is provided to punch through the rounded top surface 152 of the metal sheet 15, thus a preformed hole 18 is defined in the metal sheet 15. A size of the preformed hole 18 is less than that of the circular flanged hole 12. The preformed hole 18 can also be formed by a twist drill bit.

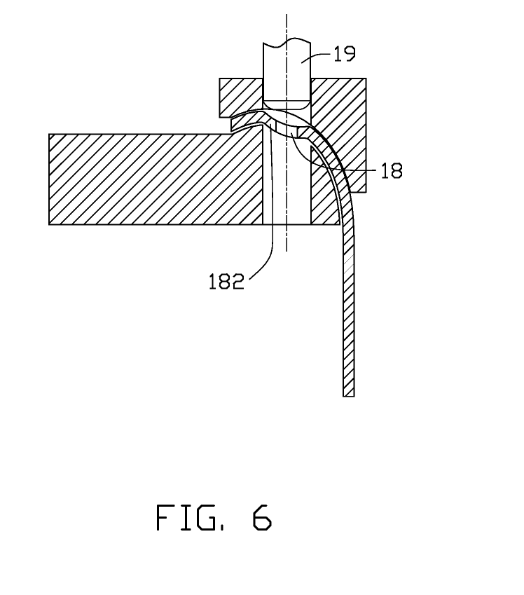

Referring to FIG. 6, in a second step, a second punch 19 is provided to punch a circumferential portion of the preformed hole 18 to form a protruded portion 182. A size of the second punch 19 is larger than that of the first punch 16. The protruded portion 182 is larger than the preformed hole 18.

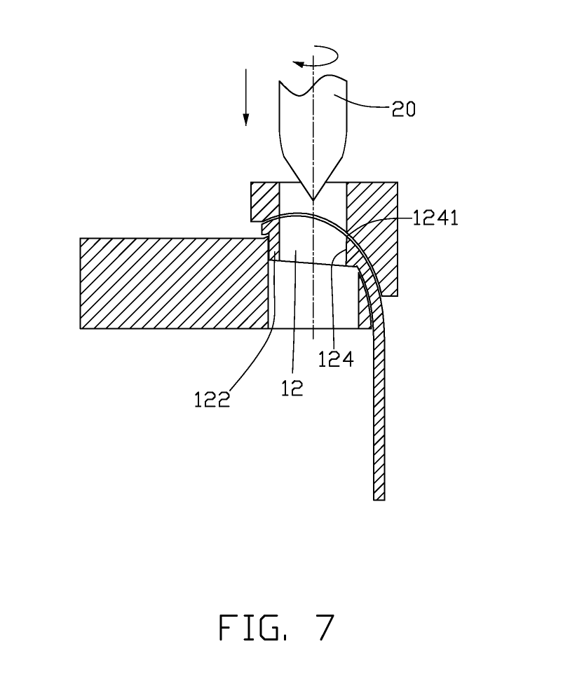

Referring also to FIG. 7, in a third step, the preformed hole 18 is made into the flanged hole 12 by a drill bit 20. In the process of making the preformed hole 18 into the flanged hole 12, the drill bit 20 is first aimed at the preformed hole 18. The drill bit 20 is driven by a driving device (not shown) such as a motor, thus the drill bit 20 is gradually drilled into the preformed hole 18. The metallic material adjacent to the preformed hole 18 is gradually displaced by the drill bit 20 forming the flange 122, thus, the preformed hole 18 is made into the flanged hole 12. The drill bit 20 is rotatedly moved to enlarge the preformed hole 18, thereby preventing the inside surface 124 of the flange 122 from being scratched by any impurity particles accidentally adhered to the drill bit 20. Furthermore, the shape of the circular flanged hole 12 will be circular even if the drill bit 20 is scratched or abraded, thereby increasing the quality of the inside surface 124 of the flange 122.

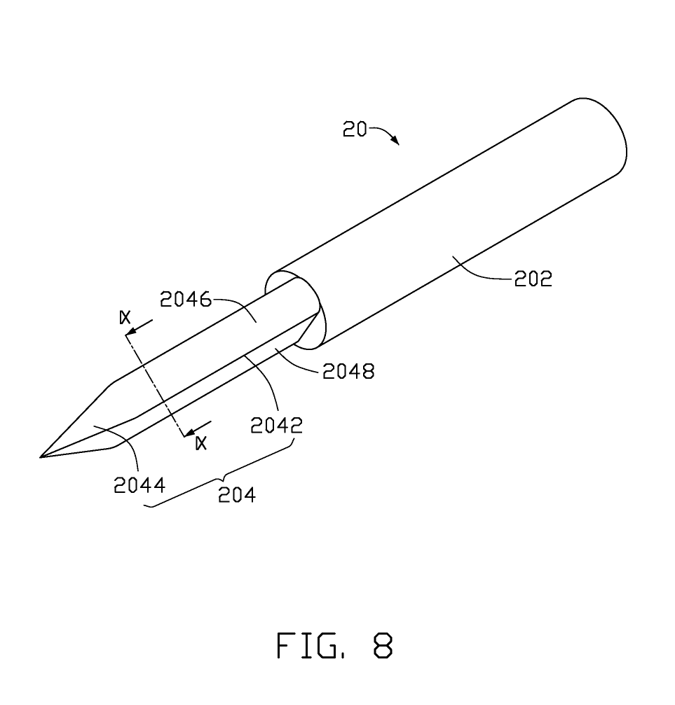

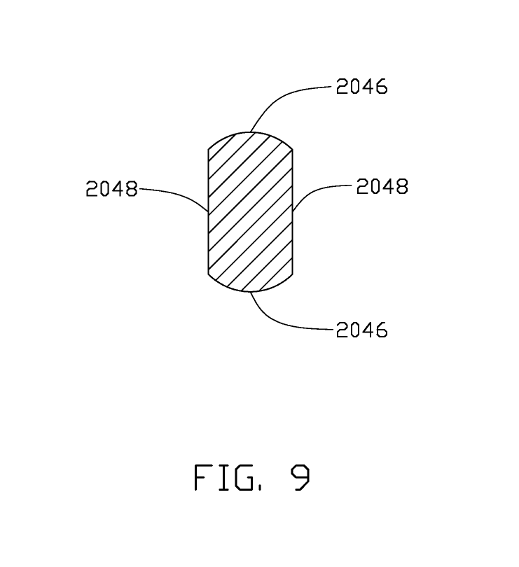

Referring to also FIG. 8, the drill bit 20 includes a shank portion 202 and a drill portion 204. The drill portion 204 extends from one end of the shank portion 202. The shank portion 202 is cylindrical and has a size larger than that of the drill portion 204. The shank portion 202 is configured for connecting to the driven device. The drill portion 204 includes a cutting edge 2042 connecting the end of the shank portion 202 and a starting point 2044 adjoining the cutting edge 2042. The cutting edge 2042 is a non-circular portion. The starting point 2044 is smaller than the cutting edge 2042. Referring to FIG. 9, a cross-section of the cutting edge 2042 is shown, the cutting edge 2042 includes a pair of rounded surfaces 2046 and a pair of flat surfaces 2048. In the illustrated embodiment, the starting point 2044 is a pyramidal portion extending from an end of the cutting edge 2042.

As described above, the drill bit 20 drills into the preformed hole 18, thus the cutting edge 2042 and the starting point 2044 successively displace the material adjoining the preformed hole 18 to form the flange 122. When the drill bit 20 rotates in the preformed hole 18, a friction is produced between the material adjoining the preformed hole 18 and the drill bit 20, thereby increasing the temperature of the material adjoining the preformed hole 18. The material adjoining the preformed hole 18 gets softened because of increase of the temperature, thus ductility of the material is improved and tensile deformation of the material is reduced. Therefore, the quality of the flanged hole 12 is greatly improved, for example, the edge portion 1241 of the flanged hole 12 is substantially sharp-cornered edge, and R/T<0.4 or even less than 0.2, wherein R represents the radius of the edge surface 1242 of the edge portion 1241 and T the represents the thickness of the base portion.

In alternative embodiments, the cutting edge 2042 of the drill portion 204 are other shapes such as a regular triangular prism, and a regular pentagonal prism. The rounded top surface 142 of the base portion 14 is replaced by a flat top surface. The inside surface 324 is perpendicular to the flat top surface 342.flat top surface. Thus, in the method for making such metal structure, the second step for forming a protruded portion is omitted correspondingly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A metal structure, comprising:
a base portion defining a circular flanged hole;
a flange extending from a top surface of the base portion and the flange surrounding the circular flanged hole; and
an edge portion for connecting an inside surface of the flange and the top surface of the base portion, the edge portion including an edge surface; and wherein a ratio of a radius of the edge surface of the edge portion with respect to a thickness of the base portion is less than 0.4.

2. The metal structure as claimed in claim 1, wherein the edge portion of the circular flanged hole is a sharp-cornered edge.

3. The metal structure as claimed in claim 1, wherein the metal structure is made of metallic material selected from a group consisting of steel, aluminum, aluminum alloy, magnesium alloy, and copper.

4. The metal structure as claimed in claim 1, wherein the top surface of the base portion is a rounded top surface.

5. The metal structure as claimed in claim 4 wherein the rounded surface is one of convex and concave.

6. The metal structure as claimed in claim 1, wherein the top surface of the base portion is a flat top surface.

7. The metal structure as claimed in claim 6, wherein the inside surface of the flange is oblique to the flat top surface of the base portion.

8. The metal structure as claimed in claim 6, wherein the inside surface of the flange is perpendicular to the flat top surface of the base portion.

9. A method for making a circular flanged hole in a metal sheet, comprising:
punching through a metal sheet to form a preformed hole by a first punch;
punching a circumferential portion of the preformed hole by a second punch to form a protruded portion, and a size of the second punch is larger than that of the first punch; and
forming a flange surrounding the preformed hole by a drill bit.

10. The method as claimed in claim 9, wherein the metal sheet comprises a rounded surface, and the first punch punches though the rounded surface.

11. The method as claimed in claim 9, wherein the metal sheet comprises a flat top surface, and the first punch punches through the flat top surface.

12. The method as claimed in claim 9, wherein the drill bit comprises a shank portion and a drill portion extending from one end of the shank portion, the shank portion is cylindrical and has a size larger than that of the drill portion.

13. The method as claimed in claim 12, wherein the drill portion includes a cutting edge connecting to the end of the shank portion and a starting point smaller than the cutting edge adjoining the cutting edge.

14. The method as claimed in claim 14, wherein the cutting edge is a non-circular portion and the starting point is a pyramidal portion extending from an end of the cutting edge.

15. The method as claimed in claim 15, wherein the cutting edge includes a pair of rounded surfaces and a pair of flat surfaces.
